(19) United States
(12) Patent Application Publication
(10) Pub. No.: US 2005/0207344 A1
(43) Pub. Date: Sep. 22, 2005

(54) Data transfer apparatus and image server

(75) Inventor: Yoshihide Yamashiro, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Sanyo Electric Co., Ltd., Moriguchi-shi (JP)

(21) Appl. No.: 11/079,115

(22) Filed: Mar. 15, 2005

(30) Foreign Application Priority Data
Mar. 18, 2004 (JP) 2004-079245
Nov. 10, 2004 (JP) 2004-325797

(51) Int. Cl. H04L 12/26

(52) U.S. Cl. 370/235; 370/282

(57) ABSTRACT

A data transfer apparatus includes a network controller. A transfer request from a client is accepted by the network controller. A CPU transfers image data according to the accepted transfer request to a client as a request source via an available socket out of five sockets belonging to the network controller. The CPU further determines whether or not the number of data transfer operations simultaneously executed is below each of the number of sockets of the network controller and the number of sockets of the client as a request source. The data transfer operation is acceptable when a determination result is affirmative.

### BACKGROUND OF THE INVENTION

1. Field of the invention

The present invention relates to data transfer apparatuses. More specifically, the present invention relates to a data transfer apparatus that is applicable to a surveillance camera system, and transfers desired data according to a transfer request.

Furthermore, the present invention relates to an image server distributing an image to a client.

2. Description of the Background Art

One example of such kind of a conventional apparatus is disclosed in a Japanese Patent Laying-open No. 5-191801 laid-open on Jul. 30, 1993. According to the background art, memory banks M1-Mn for temporarily storing image data are formed in a flame memory. A busy condition of the memory banks M1-Mn is managed by a bank list. When image data is input, an available memory bank is detected on the basis of the bank list. The input image data is written to the detected memory bank. The image data stored in the memory bank is then output to a monitor.

Since the memory bank and the monitor are connected with each other by a bus in the background art, it is possible to precisely control the data transfer to the monitor by grasping a busy condition of the memory bank. On the other hand, in a case that an output destination of the data is an apparatus connected via a communication line such as the Internet or an intranet, it is necessary to notice a parameter except for the busy condition of the memory bank in order to avoid failure of a data transfer process. The background art does not assume the data transfer to the apparatus connected via the communication line, and there is not any disclosure about a method of avoiding such the failure of the data transfer process.

Furthermore, for example, in a conventional network image distribution for transmitting to the client images from a plurality of surveillance cameras via the network, it is necessary to view the images from the plurality of surveillance cameras in order to confirm a state of a surveillance object on the client side, but at that time, an image is updated after one sheet of image data is entirely transmitted in the browser on the client side. That is, an image update is performed only after one sheet of image data is entirely received. Furthermore, a multi-screen display is utilized in order to confirm a plurality of surveillance objects at one time, and a method in which the multi-screen is created by combining screens on the server side, one sheet of the created multi-screen is distributed to the client side, and the distributed multi-screen is displayed on the client side is taken in order to display the multi-screen on the client side.

When the multi-screen is created on the server side to deliver the image, a resolution of an image of each of the channels (for each surveillance camera) causes deterioration in resolution such as reduction of the resolution of the image to half or ⅓, etc. On the other hand, when one sheet of image is distributed for each channel, an image of a following channel is not requested without the client receiving the image, resulting in a low image updating speed.

Furthermore, the multi-screen to be created for distributing images to the server side is similar to a multi-display screen to be output on a monitor of the recording apparatus for recording an image for each channel. By distributing the multi-screen to the client, the client on the network can display the multi-screen, but the image is the same as the output image from the recording apparatus, and thus, the image output in an output screen mode of the recording apparatus is the same as the screen output on the network.

In addition, in a conventional multi-user management, an image distribution is performed regarding a user request in the low level and a user request in the high level as the same on the server side, and therefore, in some cases, a user of the low level request results in a low image updating speed in the multi-user access.

### SUMMARY OF THE INVENTION

Therefore, it is a primary advantage of the present invention to provide a novel data transfer apparatus or an image server.

Another advantage of the present invention is to provide a data transfer apparatus capable of precisely controlling a data transfer operation to an apparatus connected via a communication line.

A data transfer apparatus according to the present invention, comprises: an acceptor for accepting a transfer request for requesting data transfer to a data processing apparatus having M (M: is two or more integer) first sockets; N (N: is two or more integer) second sockets; a transferor for transferring to the data processing apparatus data according to the transfer request accepted by the acceptor via an available second socket out of the N second sockets; a determiner for determining whether or not the number of transfer operations simultaneously executed by the transferor is below each of the M and N; and a controller for allowing the transfer operation by the transferor when a determination result by the determiner is affirmative.

The data processing apparatus has the M first sockets. The acceptor accepts the transfer request for requesting the data transfer to such the data processing apparatus. The transferor transfers to the data processing apparatus the data according to the transfer request accepted by the acceptor via the available second socket out of the N second sockets. Furthermore, the determiner determines whether or not the number of transfer operations simultaneously executed by the transferor is below each of M and N. The transfer operation by the transferor is allowed by the controller when the determination result by the determiner is affirmative.

Accordingly, in a case of M>N, a further transfer operation is allowed until the number of transfer operations to be simultaneously executed reaches the N. On the other hand, in a case of M≦N, a further transfer operation is allowed until the number of transfer operations to be simultaneously executed reaches the M. By such the transfer control, an optimal data transfer control taking the first number of sockets and the second number of sockets into account is realized.

It is preferable that a former forms memory areas corresponding to a smaller numerical value out of the M and the N within an internal memory. An assignor respectively assigns the memory areas formed by the former to the transfer operations to be simultaneously executed by the transferor. Thus, it is possible to efficiently utilize a capacity of the internal memory.

It is preferable that a plurality of channels of data is fetched by a fetcher. Furthermore, the transfer request includes channel information indicative of any one of the plurality of channels, and the transferor includes an extractor for extracting data corresponding to the channel information.

It is preferable that the transferor further includes a compressor for compressing the data extracted by the extractor. The transfer amount is controlled by the data compression.

It is preferable that the fetcher includes a multiplexer for multiplexing data of each of the plurality of channels by a predetermined amount, and the amount of data extracted by the extractor is equal to the predetermined amount.

It is preferable that the fetcher includes a selector for selecting each of the plurality of channels in a predetermined order, and the extractor waits for appearance of data of the channel according to the transfer request.

It is preferable that the acceptor accepts the transfer request from the data processing apparatus.

It is preferable that the data processing apparatus issues an access request prior to the transfer request. A detector detects the number of first sockets belonging to the data processing apparatus in response to the access request.

It is preferable that the data to be transferred by the transferor is image data of an object scene imaged by a surveillance camera.

According to the present invention, a data transfer program to be executed by a processor of a data transfer apparatus, comprises: an accepting step for accepting a transfer request for requesting data transfer to a data processing apparatus having M (M: is two or more integer) first sockets; a transferring step for transferring to the data processing apparatus data according to the transfer request accepted by the accepting step via an available second socket out of the N second sockets; a determining step for determining whether or not the number of transfer operations simultaneously executed by the transferring step is below each of the M and the N; and a controlling step for allowing the transfer operation by the transferring step when a determination result by the determining step is affirmative.

Thus, similarly to the above description, an optimal data transfer control taking the first number of sockets and the second number of sockets into account is realized.

According to the present invention, a plurality of requests can simultaneously be accepted in response to a request from the client, and screens of respective channels are arranged on a multi-screen for network display screen. This enables a network screen output different from a screen output of the main body.

By performing exclusive control and memory management on a request for each channel, and also performing exclusive control and memory management on a request for each user, it is possible to represent an efficient image updating and a difference of the image updating speed for each user.

By accepting a plurality of image distribution requests from a browser of the client, and further performing the exclusive control and the memory management for each channel, a plurality of request channels can be checked with respect to distribution requests of images sequentially input, capable of preventing the image updating speed from being lowered. Furthermore, at this time, an image for each channel is distributed, capable of-making a different output between a screen mode of the main body and a screen mode of the network screen. Furthermore, by additionally providing the exclusive control and the memory management with respect to the user management, a user in the low request level is never faster in the image updating speed than a user in the high requesting level.

That is, by use of the invention according to this application, it is possible to make an output of the network screen mode different from the screen mode of the recording apparatus main body, and by performing the exclusive control and the memory management for each channel that allows a plurality of accesses from the client, it is possible to improve the image updating speed, and realize a difference of the image updating speeds in the multi-user.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an illustrative view showing a configuration of one embodiment of the present invention;

FIG. 2 is a block diagram showing one example of a configuration of a server applicable to a FIG. 1 embodiment;

FIG. 3 is an illustrative view showing one example of a mapping state of an SDRAM applicable to FIG. 1 embodiment;

FIG. 4 is an illustrative view showing one example of an image to be displayed on a monitor applicable to FIG. 1 embodiment;

FIG. 5 is an illustrative view showing another example of a mapping state of the SDRAM applicable to FIG. 1 embodiment;

FIG. 6 is an illustrative view showing one example of a request list applicable to FIG. 1 embodiment;

FIG. 7 is a an illustrative view showing one example of a bank list applicable to FIG. 1 embodiment;

FIG. 8 is a flowchart showing one part of an operation of a CPU applicable to FIG. 1 embodiment;

FIG. 9 is a flowchart showing another part of the operation of the CPU applicable to FIG. 1 embodiment;

FIG. 10 is a flowchart showing the other part of the operation of the CPU applicable to FIG. 1 embodiment;

FIG. 11 is a flowchart showing a further part of the operation of the CPU applicable to FIG. 1 embodiment;

FIG. 12 (A) is a waveform chart showing a generation timing of a vertical synchronization signal;

FIG. 12 (B) is an illustrative view showing one example of a channel switching timing of input image data;

FIG. 12 (C) is an illustrative view showing one example of an accepting timing of a transfer request;

FIG. 12 (D) is a timing chart showing one example of an access operation to a bank 1;

FIG. 12 (E) is a timing chart showing one example of an access operation to a bank 2;

FIG. 12 (F) is a timing chart showing one example of an access operation to a bank 3;

FIG. 12 (G) is a timing chart showing one example of an access operation to a bank 4;

FIG. 13 (A) is a waveform chart showing one example a generation timing of a vertical synchronization signal;

FIG. 13 (B) is an illustrative view showing one example of a channel switching timing of input image data;

FIG. 13 (C) is an illustrative view showing one example of an accepting timing of a transfer request;

FIG. 13 (D) is a timing chart showing one example of an access operation to the bank 1;

FIG. 13 (E) is a timing chart showing one example of an access operation to the bank 2;

FIG. 13 (F) is a timing chart showing one example of an access operation to the bank 3;

FIG. 13 (G) is a timing chart showing one example of an access operation to the bank 4;

FIG. 13 (H) is a timing chart showing one example of an access operation to the bank 5;

FIG. 14 is a block diagram showing one example of a configuration of a server side of another embodiment of the present invention;

FIG. 15 is a system configuration view consisting of the server side and a client side of the other embodiment of the present invention;

FIG. 16 is a flowchart showing an operation of the server side of the other embodiment of the present invention; and

FIG. 17 is a timing chart showing a channel control system and a conventional system of the other embodiment of the present invention.

### DETAILED DESCRIPTION OF THE PREFERRED EMBODIMENTS

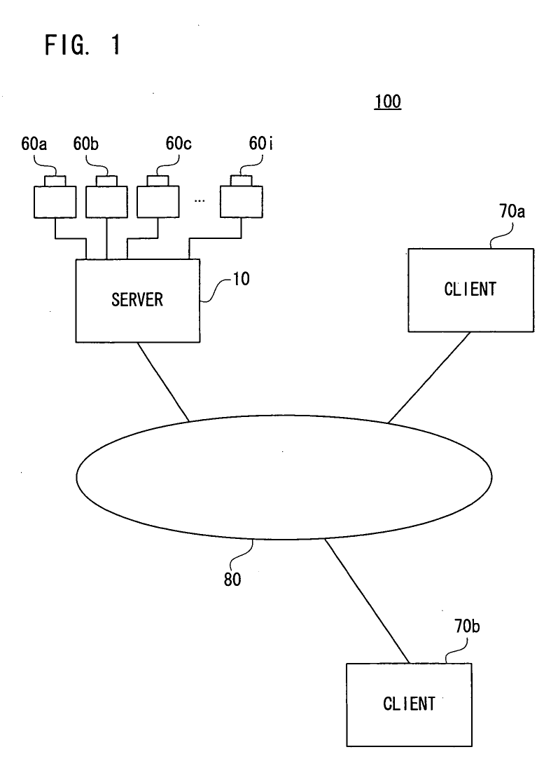

Referring to FIG. 1, a surveillance camera system 100 in this embodiment includes a server 10 with which 9 surveillance cameras 60a-60i are connected. The server 10 is connected with clients 70a and 70b via the Internet 80. When the client 70a or 70b issues a transfer request to the server 10, image data of an object scene imaged by any one of the surveillance cameras 60a-60i is output from the server 10. The output image data is transferred to the client issuing a transfer request via the Internet 80.

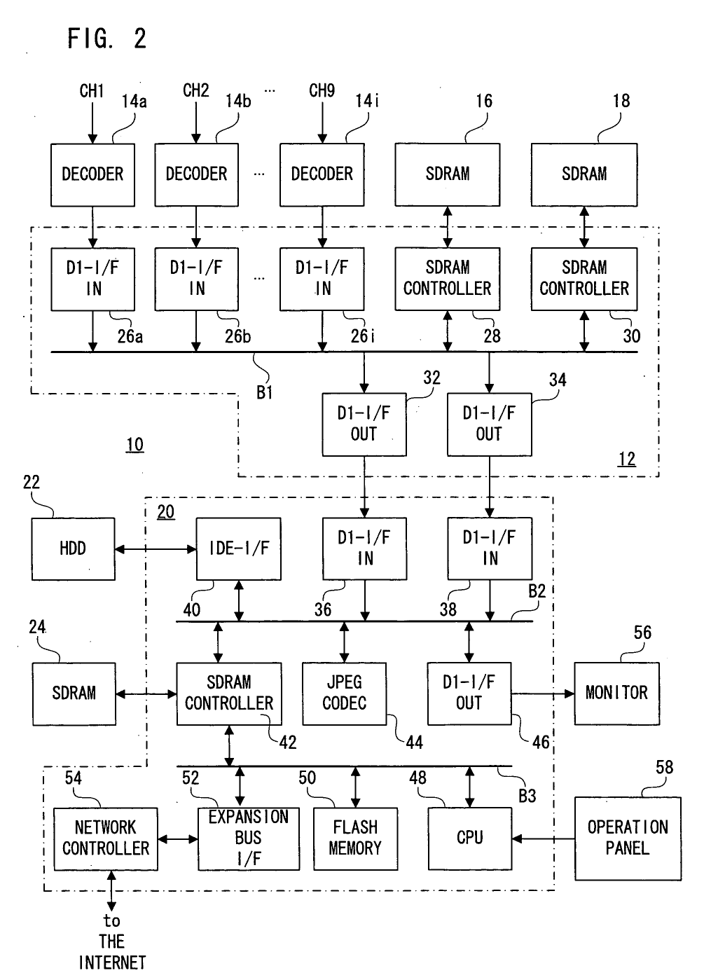

The server 10 is specifically constituted as shown in FIG. 2. The surveillance cameras 60a-60i output image data CH1-CH9, respectively. The output image data of 9 channels are decoded by decoders 14a-14i, respectively. The decoded image data of 9 channels are converted into data formats complying with the D1 format by respective D1-I/Fs 26a-26i provided in a multiplexer 12. The converted image data of 9 channels are output from the respective D1-I/Fs 26a-26i with frame synchronization maintained with each other, and applied to each of SDRAM controllers 28 and 30 via a bus B1.

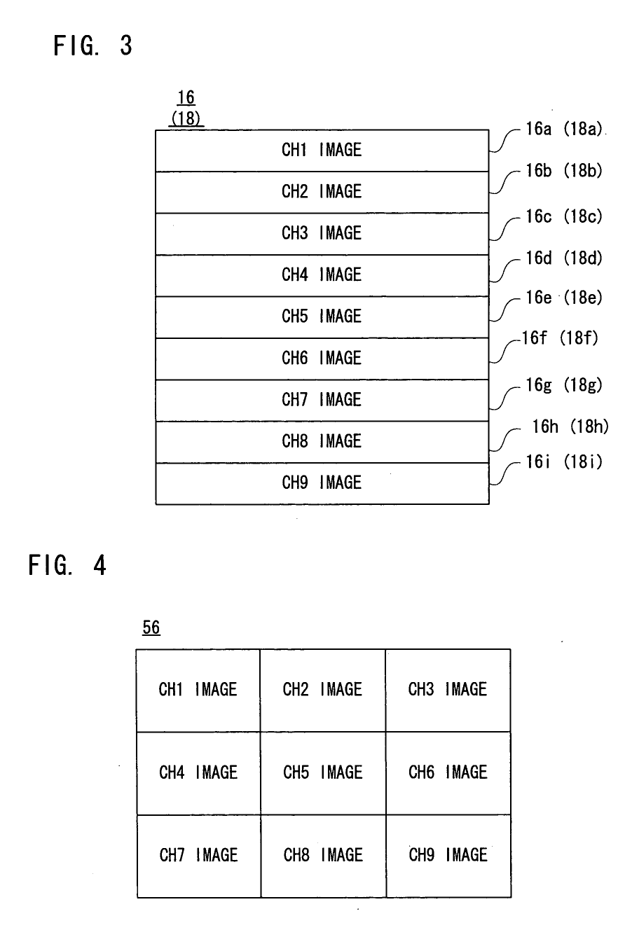

The SDRAM controller 28 circularly switches a channel every time that a vertical synchronization signal Vsync is generated from a signal generator (not shown) in an order of CH1→CH2→CH3→CH4→CH5→CH6→CH7→CH8→CH9→CH1→. . . , and writes one frame of image data belonging to a selected channel to an SDRAM16. The SDRAM16 has 9 memory banks 16a-16i as shown in FIG. 3, and the image data of 9 channels are written to the 9 memory banks 16a-16i, respectively. The SDRAM controller 28 further reads the image data from the memory banks 16a-16i in an order corresponding to raster scanning of a monitor screen, and performs a thinning-out process on the read image data.

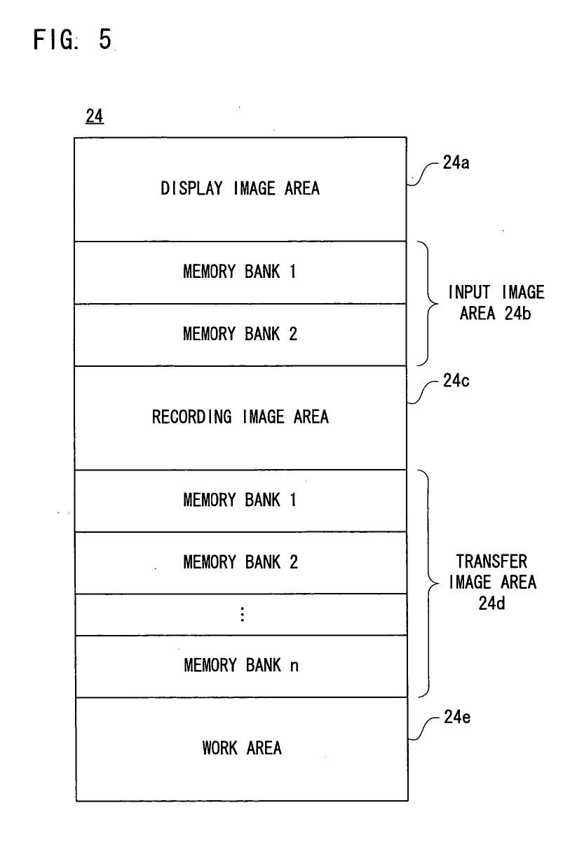

The image data reduced in resolution by the thinning-out process is output from the multiplexer 12 via a D1-I/F 32, and applied to a D1-I/F 36 provided in a video recorder 20. The D1-I/F 36 inputs the applied image data to an SDRAM controller 42 via a bus B2, and the SDRAM controller 42 writes the input image data to an SDRAM 24. Referring to FIG. 5, the SDRAM 24 has a display image area 24a, and the image data from the D1-I/F 36 is written to the display image area 24a. A D1-I/F 46 reads the image data stored in the display image area 24a via the SDRAM controller 42, and outputs the read image data to the monitor 56. As a result, surveillance images of 9 channels are displayed on the monitor screen as shown in FIG. 4.

Returning to FIG. 2, the SDRAM controller 30 provided in the multiplexer 12 also circularly switches a channel in an order of CH1→CH2→CH3→CH4→CH5→CH6→CH7→CH8→CH9→CH1→. . . every time that a vertical synchronization signal Vsync is generated, and writes one frame of image data belonging to a selected channel to the SDRAM 18. As shown in FIG. 3, the SDRAM 18 also has 9 memory banks 18a-18i. The image data of 9 channels are written to the 9 memory banks 18a-18i, respectively.

The SDRAM controller 30 sequentially gains access to the memory banks 18a-18i, and reads the image data of 9 channels in an order the same as in writing. The image data is read by one frame in an order of CH1→CH2→CH3→CH4→CH5→CH6→CH7→CH8→CH9→CH1→. . . every time that a vertical synchronization signal Vsync is generated. The read image data is output from the multiplexer 12 via a D1-I/F 34, and applied to a D1-I/F 38 of the video recorder 20. The D1-I/F 38 writes the applied image data to an input image area 24b (see FIG. 5) of the SDRAM 24 through the SDRAM controller 42. The input image area 24b has memory banks 1 and 2 each having a capacity corresponding to one frame, and the image data stored in each of the memory banks 1 and 2 is overwritten by image data of a following image.

When a channel designating operation and a recording starting operation are performed by an operation panel 58, a CPU 48 respectively applies a compression instruction and a recording instruction to a JPEG codec 44 and an IDE-I/F 40 at a timing when the image data of the designated channel is stored in the input image area 24b.

To the compression instruction, a head address of the memory bank in which the image data of the designated channel is stored is assigned as a reading address, and an address within a recording image area 24c is assigned as a writing address. Furthermore, an address the same as the writing address that is assigned to the compression instruction is assigned to the recording instruction as a reading address.

The JPEG codec 44 reads one frame of image data belonging to the designated channel through the SDRAM controller 42 from the input image area 24b, compresses the read image data in the JPEG format, and writes compressed image data to the recording image area 24c through the SDRAM controller 42. The IDE-I/F 40 reads the compressed image data stored in the recording image area 24c through the SDRAM controller 42, and applies the read compressed image data to an HDD 22. The compressed image data is recorded in the hard disk (not shown) by the HDD 22.

A network controller 54, when accepting a transfer request issued by a client 70a or 70b via the Internet 80, applies the transfer request to the CPU 48 via an expansion bus I/F 52 and a bus B3. The transfer request includes requesting source address information and requesting channel information.

The CPU 48 issues a compression instruction to the JPEG codec 44 at a timing when the image data of a requesting channel, that is, a channel indicated by the requesting channel information is stored in the input image area 24b. To the compression instruction, a head address of the memory bank in which image data of the requesting channel is stored is assigned as a reading address, and an address within the transfer image area 24d is assigned as a writing address.

As described above, the JPEG codec 44 reads one frame of the image data belonging to the requesting channel from the input image area 24b through the SDRAM controller 42, compresses the read image data in the JPEG format, and then, writes compressed image data to the transfer image area 24d through the SDRAM controller 42.

When one frame of the compressed image data corresponding to the requesting channel is retained in the transfer image area 24d, the CPU 48 issues a transfer instruction to the network controller 54. To the transfer instruction, an address the same as the address assigned to the compression instruction as the writing address is assigned as a reading address, and an address indicated by the requesting source address information is assigned as a transfer destination address.

The network controller 54 gains access to the SDRAM 24 via the expansion bus I/F 52, the bus B3 and the SDRAM controller 42, and reads one frame of the compressed image data from the transfer image area 24d according to the reading address assigned to the transfer request. The network controller 54 further transfers the read compressed image data to the transfer destination address assigned to the transfer request. Thus, one frame of the compressed image data belonging to the requesting channel is transferred to the client issuing a transfer request.

It is noted that data transfer via the Internet 80 utilizes an interprocess communication interface on the basis of the TCP/IP. The interface is the API (Application Programming Interface) defined between an application layer and a transport layer, and called a “socket”, a “socket•interface” or a “socket API”. A data transfer processing at one time needs one socket. Thus, both of the apparatuses of the transfer source and the transfer destination need N-sockets in order to simultaneously executing N-data transfer processes.

In this embodiment, the server 10, that is, the network controller 54 has 5 sockets, the client 70a has 4 sockets, and the client 70b has 6 sockets. Accordingly, the data transfer processing that can be simultaneously executed between the server 10 and the client 70a is restricted to 4, and the data transfer processing that can be simultaneously executed between the server 10 and the client 70b is restricted to 5.

Thus, a restriction different from a restriction imposed on the data transfer processing within a single apparatus is imposed on the data transfer processing via the communication line such as the Internet 80. Here, in this embodiment, a data transfer control described later is executed on the basis of the number of sockets belonging to each of the server 10, the clients 70a and 70b.

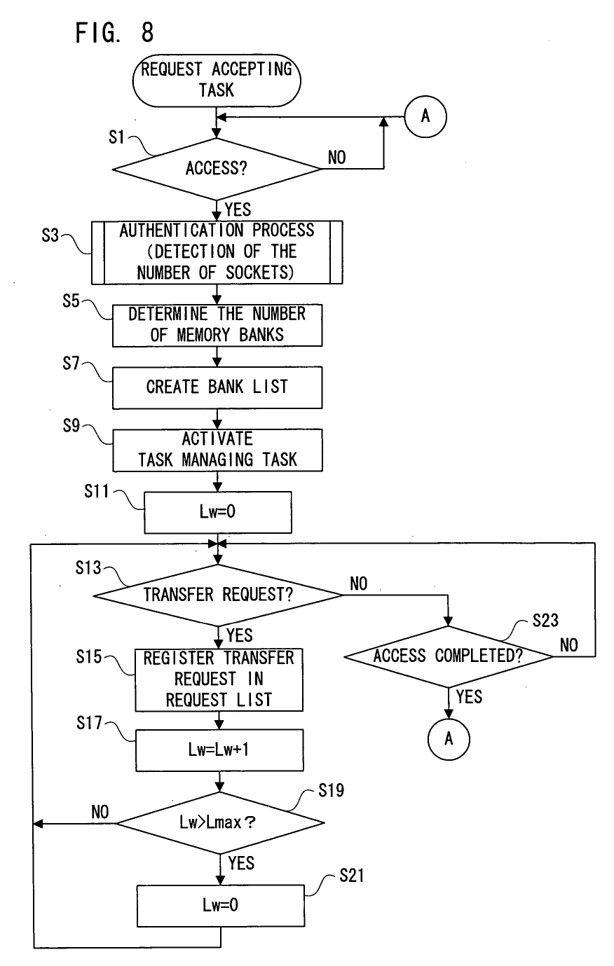

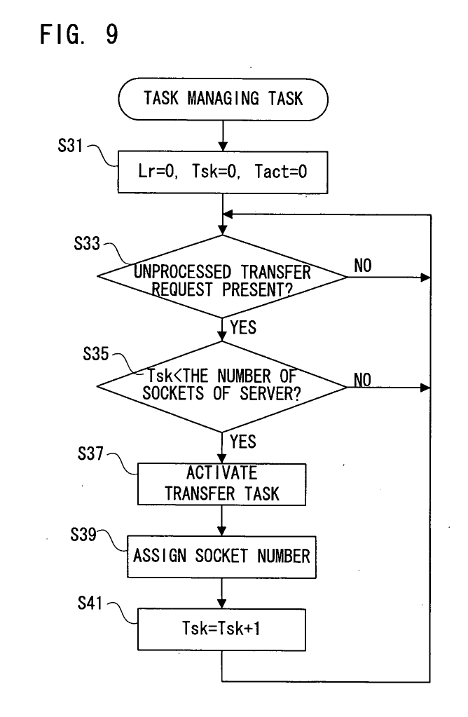

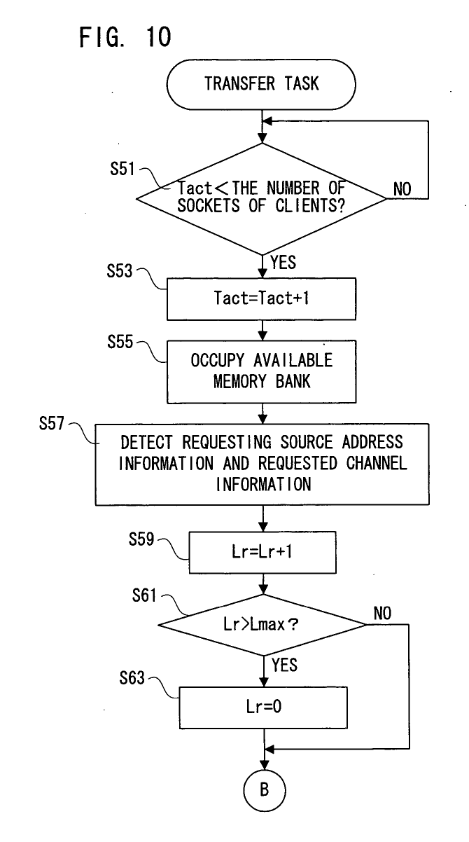

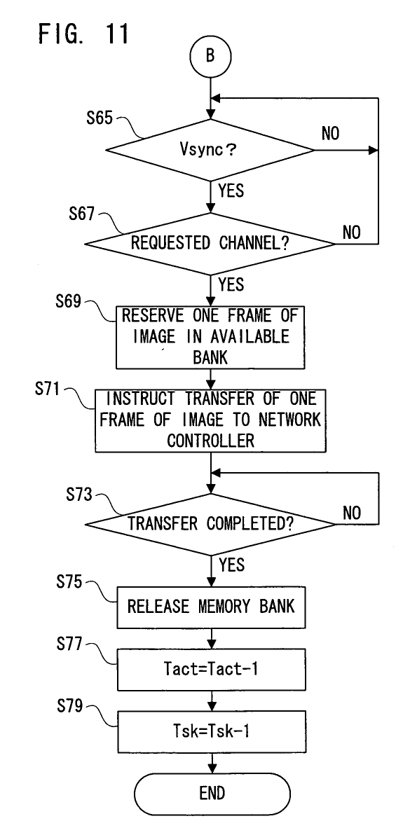

The CPU 48 executes a request accepting task shown in FIG. 8, a task managing task shown in FIG. 9, and a transfer task shown in FIG. 10-FIG. 11 in parallel in relation to the data transfer. It is noted that the control programs corresponding to these tasks are stored in a flash memory 50. Furthermore, these tasks are executed under the control of a multitasking OS such as the μITRON.

Referring to FIG. 8, it is determined whether or not an access request is accepted through the network controller 54 in a step S1. If “YES” here, the process proceeds to a step S3 to execute an authentication process for authenticating whether or not the requesting source is a proper client. Furthermore, if the requesting source is the proper client, that is, the client 70a or 70b shown in FIG. 1, the number of sockets belonging to the client of the requesting source is detected.

In a step S5, the number of memory banks is determined on the basis of the number of sockets detected in the step S3, and the memory banks corresponding to the detected number are formed in the image transfer area 24d shown in FIG. 5. If the number of sockets of the requesting source is above the number of sockets of the network controller 54, the memory banks corresponding to the number of sockets of the network controller 54 are formed in the image transfer area 24d. In contrast thereto, the number of sockets of the requesting source is equal to or less than the number of sockets of the network controller 54, the memory banks corresponding to the number of sockets of the requesting source are formed in the image transfer area 24d.

Accordingly, when the client 70a gains access, 4 memory banks are formed in the image transfer area 24d. Furthermore, when the client 70b gains access, 5 memory banks are formed in the image transfer area 24d.

A bank list 24b (see FIG. 7) for managing the formed memory banks is created in a work area 24e of the SDRAM 24 in a succeeding step S7. The task managing task shown in FIG. 9 is activated in a step S9, and a variable Lw described later is initialized in a step S11. It is determined whether or not a transfer request is applied from the client 70 in a step S13, and it is determined whether or not an access end request is applied from the client 70 in a step S23. When the access end request is applied, “YES” is determined in the step S23, and the process returns to the step S1.

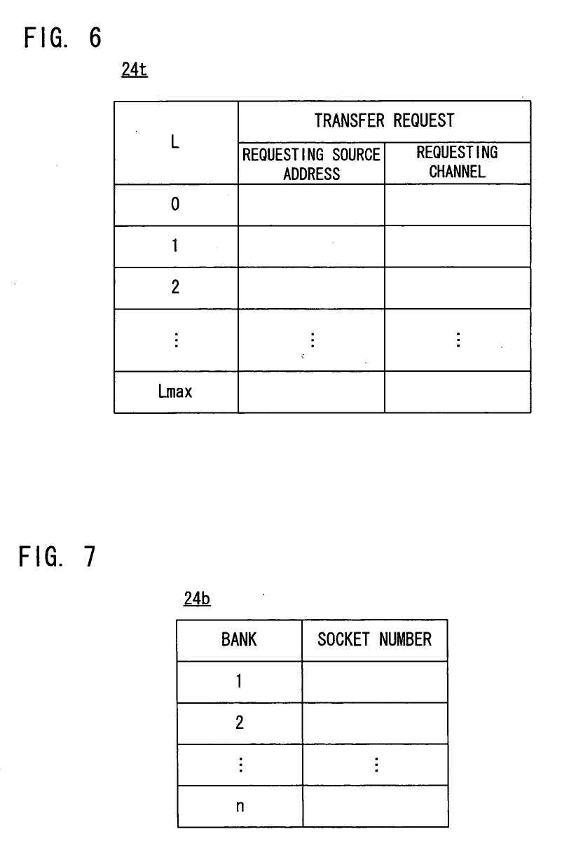

When a transfer request is applied, the process proceeds from the step S13 to a step S15 to write the transfer request to a request list 24t (see FIG. 6) formed in the work area 24e of the SDRAM 24. Both of the requesting source address information and requesting channel information included in the transfer request are written to a column in correspondence to an index number Lw. It is noted that the variable Lw indicates an index number of a column to which the accepted transfer request is to be written.

The variable Lw is incremented in a step S17, and it is determined whether or not the variable Lw is above a maximum index number Lmax in a step S19. If “NO” here, the process directly returns to the step S13, and if “YES”, the variable Lw is initialized in a step S21, and then, the process returns to the step S13. Accordingly, the column to which the transfer request is to be written is circularly updated on the request list 24t.

Referring to FIG. 9, variables Lr, Tsk and Tact are initialized in a step S31. Here, the variable Lr is a variable indicative of an index number of the column in which the transfer request to be processed is registered. Furthermore, the variable Tsk is a variable indicative of the number of activated transfer tasks, and the variable Tact is a variable indicative of the number of transfer tasks on execution.

It is determined whether or not the transfer request that was registered in the request list 24t but has not yet been processed exists in a step S33. Furthermore, it is determined whether or not the variable Tsk is below the number of sockets (=5) of the network controller 54 in a step S35. If “YES” is determined in both of the steps S33 and S35, the transfer task shown in FIG. 10-FIG. 11 is activated in a step S37. In a step S39, an available socket is detected from among a plurality of sockets belonging to the network controller 54, and an identification number of the detected socket, that is, a socket number is assigned to the activated transfer task. In a step S41, the variable Tsk is incremented, and then, the process returns to the step S33.

Accordingly, a maximum number of the transfer task executable in parallel is “5” corresponding to the number of sockets of the network controller 54. It is noted that in a process according to the multitasking OS, a plurality of tasks are executed in parallel from a macroscopic viewpoint while any one of the plurality of tasks is only executed from a microscopic viewpoint. Thus, actually, one transfer task is prepared, and an arithmetic process executing an arithmetic operation regarding the transfer task as a function is activated up to a maximum of 5. In this embodiment, the execution of the transfer task is synonymous with the execution of the arithmetic process.

Referring to FIG. 10, the variable Tact is compared to the number of sockets of the requesting source detected in the step S3 in a step S51. If the variable Tact is below the number of sockets of the requesting source, “YES” is determined in a step S51, and the variable Tact is incremented in a step S53. An available memory bank is detected from among the plurality of memory banks formed in the transfer image area 24d to occupy the detected memory bank in a step S55. More specifically, a socket number assigned to the task itself is registered in the column of the available memory bank on the bank list 24b shown in FIG. 7. The requesting source address information and the requesting channel information assigned to the variable Lr are detected in a step S57.

The variable Lr is incremented in a step S59, and it is determined whether or not the variable Lr is above the maximum index number Imax in a step S61. If “NO” is determined, the process directly proceeds to a step S65 while if “YES” is determined, the variable Lr is initialized in a step S63, and then, the process proceeds to the step S65. Accordingly, a column from which the transfer request is to be read is also circularly updated on the request list 24t.

It is determined whether or not a vertical synchronization signal Vsync is generated in the step S65, and it is determined whether or not a channel of the image data currently written to the input image area 24b (see FIG. 5) is coincident with the requesting channel detected in the step S57 in a step S67. If “YES” in both of the steps S65 and S67, the process proceeds to a step S69 and the subsequent.

In the step S69, a compression instruction is issued to the JPEG codec 44 to retain one frame of image in the memory bank occupied by the task itself. The compression instruction to be issued includes as a reading address a head address of the memory bank on which the image data of the requesting channel is stored out of the memory banks 1 and 2 formed on the input image area 24b, and includes as a writing address a head address of the memory bank occupied in the step S55 out of the memory banks 1-n formed on the transfer image area 24d.

The JPEG codec 44 reads one frame of image data corresponding to the requesting channel from the designated memory bank of the input image area 24b, compresses the read image data in the JPEG format, and writes the compressed image data to the designated memory bank of the transfer image area 24d.

In a step S71, a transfer instruction is issued to the network controller 54 in order to transfer one frame of the image data thus retained to the client of the request source. The transfer instruction includes as a reading address the address the same as the writing address included in the compression instruction issued to the JPEG codec 44, and includes the address indicated by the requesting source address information detected in the step S57 as a transfer destination address. The transfer instruction further includes a socket number assigned to the transfer task of an issue source.

The network controller 54 gains access the SDRAM 24 via the expansion bus I/F 52, the bus B3 and the SDRAM controller 42, and reads one frame of image data from the designated memory bank of the transfer image area 24b. The network controller 54 also sends the read image data to the requesting source address via the designated socket. The image data is transferred to the client of the requesting source via the Internet 80.

It is determined whether or not the transfer processing of the network controller 54 is completed in a step S73. If “YES” here, the process proceeds to a step S75 to release the memory bank occupied by the task itself. More specifically, the socket number assigned to the task itself is erased from the bank list 24b shown in FIG. 7. The variable Tact is decremented in a step S77, the variable Tsk is decremented in a step S79, and then, the process is ended.

When the client 70a having 4 sockets gains access to the server 10, the transfer operation of the image data is executed at a timing shown in FIGS. 12(A)-12(G). At this time, 4 memory banks 1-4 are formed in the transfer image area 24d, and 4 transfer tasks are activated.

The image data input from the D1-I/F 38 is written to the input image area 24b of the SDRAM 24, taking a vertical synchronization signal Vsync shown in FIG. 12 (A) as a reference as shown in FIG. 12 (B). In a case that the client 70a issues a transfer request at a timing shown in FIG. 12 (C), the 4 transfer tasks respectively occupy the memory banks 1-4. Each of the transfer tasks executes a data transfer process at a time when the image data of the requesting channel of which the task itself is in charge is retained in the input image area 24b. Accordingly, an order of the data transfer process to be executed by the each of the transfer tasks depends on the channel number of the requesting channel.

As a result, a transfer task occupying the memory bank 1 executes the data transfer process at a timing shown in FIG. 12 (D), and a transfer task occupying the memory bank 2 executes the data transfer process at a timing shown in FIG. 12 (E). Furthermore, a transfer task occupying the memory bank 3 executes the data transfer process at a timing shown in FIG. 12 (F), and a transfer task occupying the memory bank 4 executes the data transfer process at a timing shown in FIG. 12 (G).

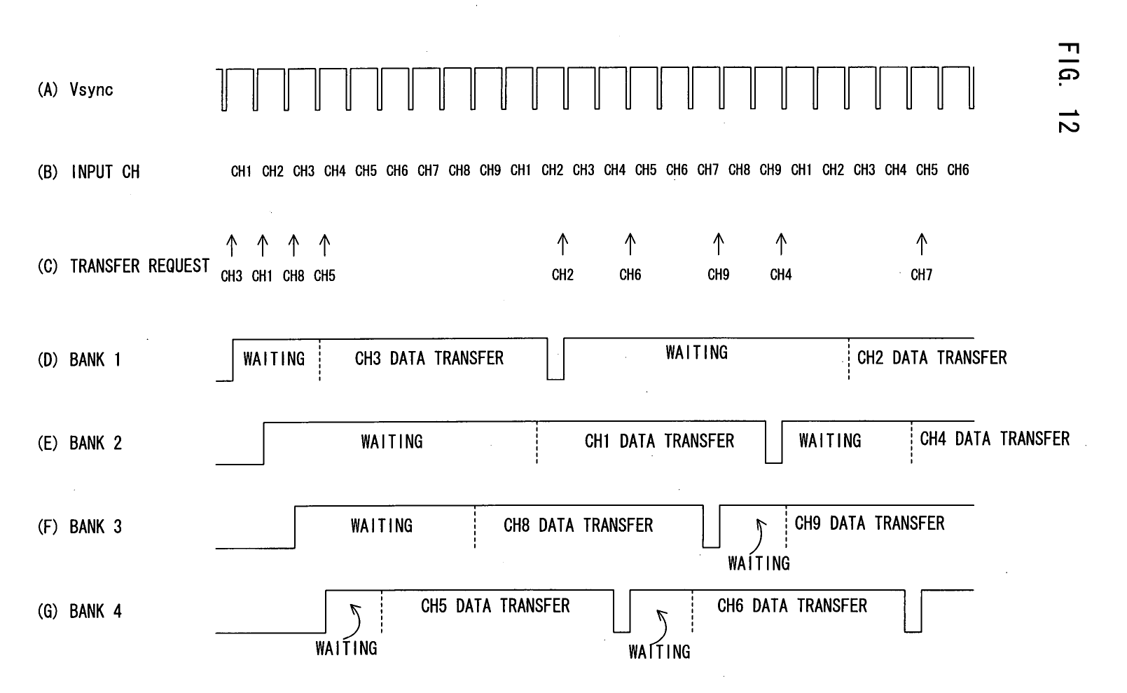

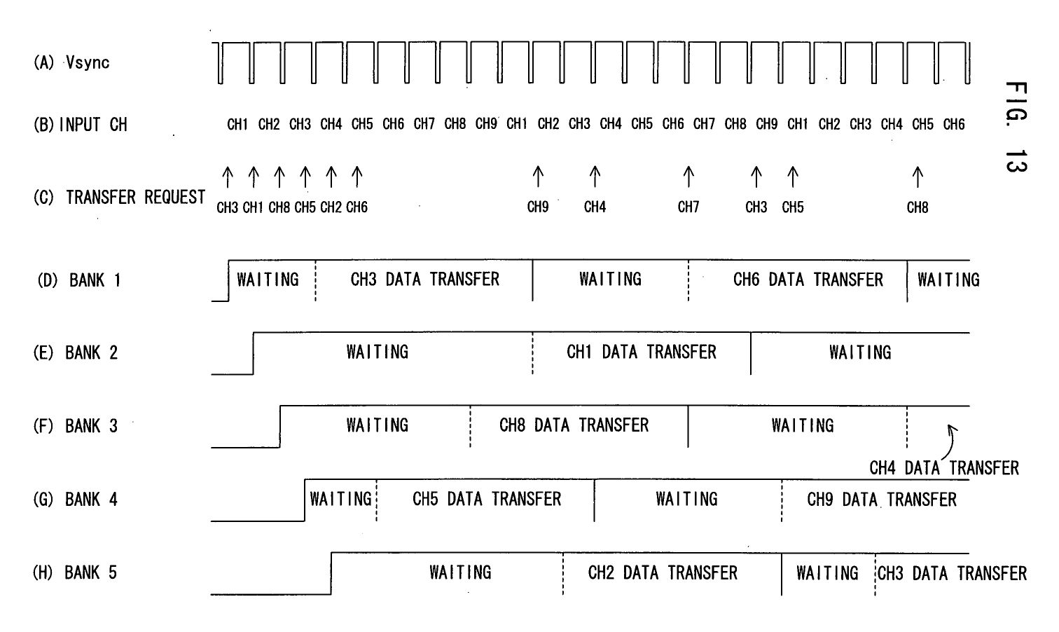

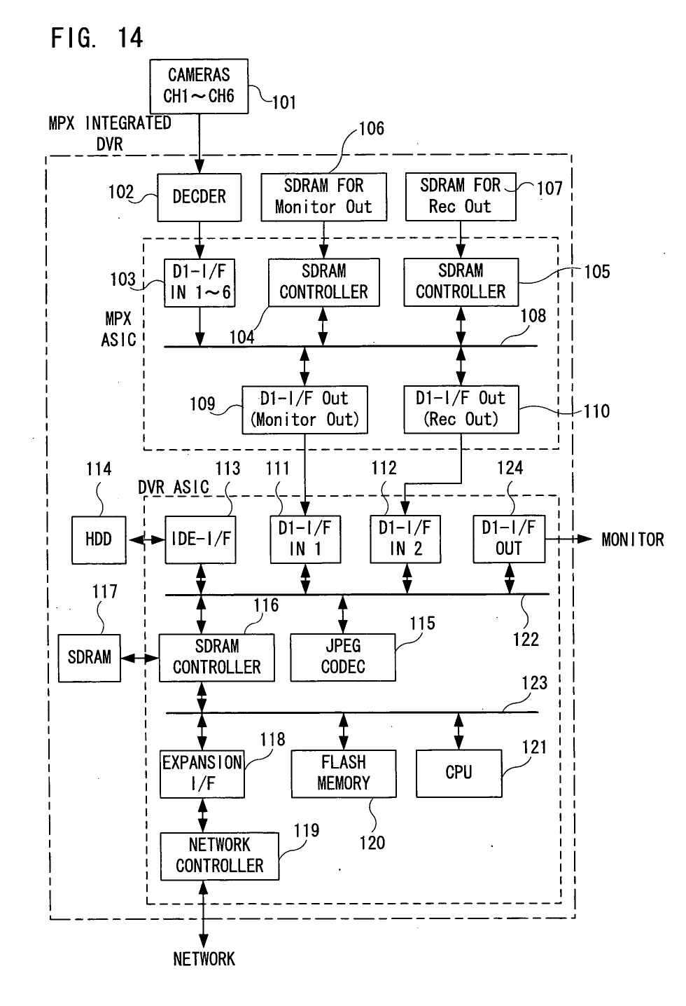

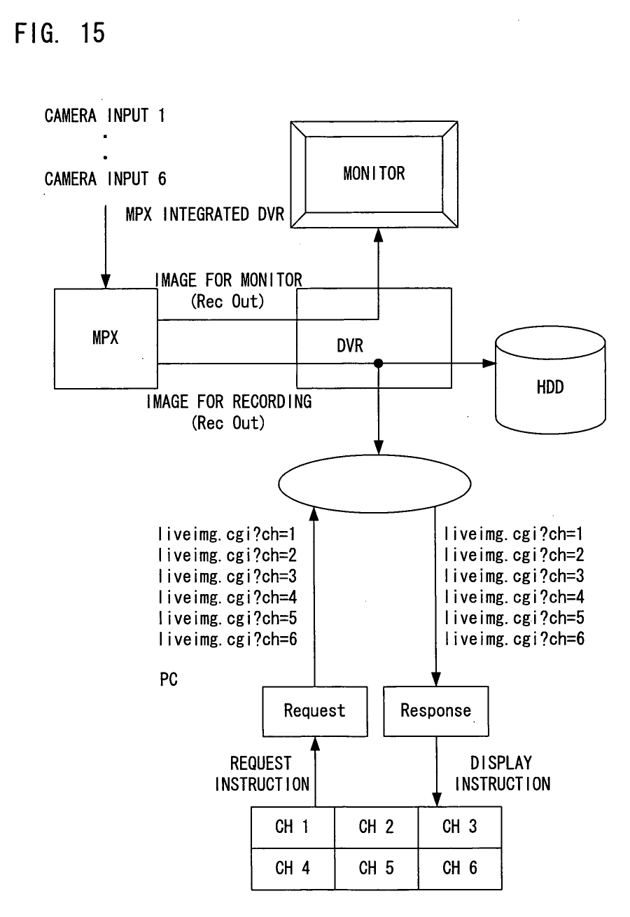

When the client 70b having 6 sockets gains access to the server 10, the transfer operation of the image data is executed at a timing shown in FIG. 13 (A)-FIG. 13 (H). At this time, 5 memory banks 1-5 are formed in the transfer image area 24d, and 5 transfer tasks are activated.

The image data input from the D1-I/F 38 is written to the input image area 24b of the SDRAM 24, taking a vertical synchronization signal Vsync shown in FIG. 13 (A) as a reference as shown in FIG. 13 (B). In a case that the client 70b issues a transfer request at a timing shown in FIG. 13 (C), the 5 transfer tasks respectively occupy the memory banks 1-5. Each of the transfer tasks executes the data transfer process at a time when the image data of the requesting channel assigned to the task itself is retained in the input image area 24b.

Accordingly, the transfer task occupying the memory bank 1 executes the data transfer process at a timing shown in FIG. 13 (D), and the transfer task occupying the memory bank 2 executes the data transfer process at a timing shown in FIG. 13 (E). Furthermore, the transfer task occupying the memory bank 3 executes the data transfer process at a timing shown in FIG. 13 (F), the transfer task occupying the memory bank 4 executes the data transfer process at a timing shown in FIG. 13 (G), and the transfer task occupying the memory bank 5 executes the data transfer process at a timing shown in FIG. 13 (H).

As can be understood from the above description, the client 70a has 4 sockets, and the client 70b has 6 sockets. Furthermore, the network controller 54 has 5 sockets. The transfer request from the client 70a or 70b is accepted by the network controller 54. The CPU 48 transfers the image data corresponding to the accepted transfer request to the client of the requesting source via an available socket out of 5 sockets belonging to the network controller 54 (S69, S71).

The CPU 48 further determines whether or not the number of transfer operations simultaneously executed is below each of the number of sockets of the network controller 54 and the number of sockets of the client of the requesting source (S35, S51). The transfer operation is accepted when the determination result is affirmative (S37, S53, S55).

Accordingly, when the transfer request from the client 70a is accepted, a further transfer operation is allowed until the number of transfer operations to be simultaneously executed reaches “4”. On the other hand, when the transfer request from the client 70b is accepted, a further transfer operation is allowed until the number of transfer operations to be simultaneously executed reaches “5”. By such the transfer control, an optimal data transfer control is realized in view of the number of sockets of the client as the requesting source and the number of sockets of the network controller 54.

It is noted that although the image data of the object scene imaged by the surveillance camera is transferred in this embodiment, the data to be transferred is not limited to the image data. That is, sound data or program data may be transferred in place of the image data.

Furthermore, although the transfer request is accepted from an outside client in this embodiment, the transfer request may be accepted through the operation panel of the server. In this case, the number of sockets of the client as a transfer destination is input through the operation panel to realize an optimal data transfer control.

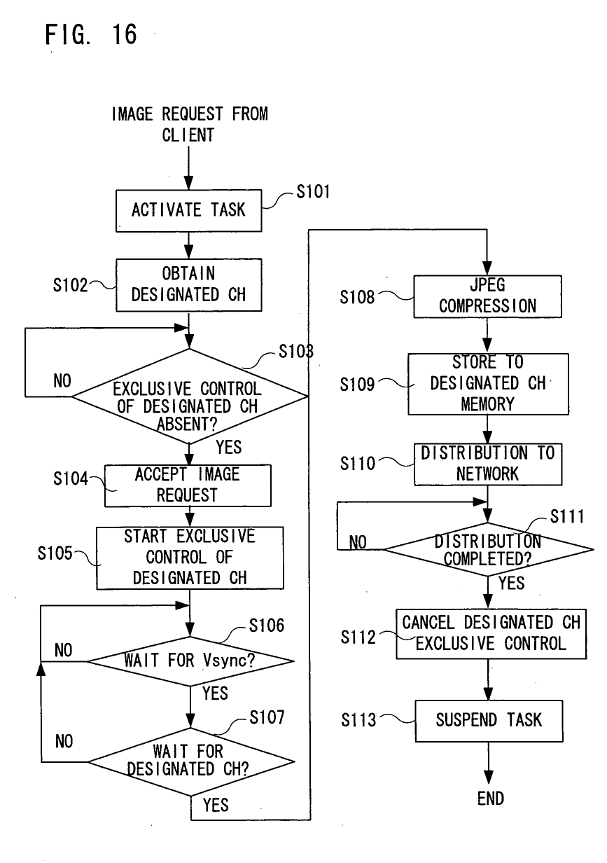

A server (image distribution apparatus) of another embodiment is shown in FIG. 14. The reference numeral 101 is a camera for photographing an image, and a decoder 102 converts an analog image signal from the camera 101 into a digital image signal. A D1-I/F (IN) 103 converts the image signal from the decoder 102 into a signal conforming to a data bus 108. An SDRAM controller 104 is a controller for controlling an SDRAM 106 for MonitorOut output, and writes the image signal from the D1-I/F (IN) 103 to the SDRAM 106 and reads the image signal from the SDRAM 106 to output it to the data bus 108. An SDRAM controller 105 is a controller for controlling an SDRAM 107 for RecOut, and writes the image signal from the D1-I/F (IN) 103 to the SDRAM 107 and reads the image signal from the SDRAM 107 to output it to the data bus 108.

The SDRAM 106 for MonitorOut includes a plurality of storage areas (banks), and the image signal is held in the plurality of storage areas. The SDRAM 107 for RecOut includes a plurality of storage areas (banks), and the image signal is held in the plurality of storage areas.

The decoder 102 is connected to the data bus 108 via the D1-I/F (IN) 103, the SDRAM 106 for MonitorOut is connected to the data bus 108 via the SDRAM controller 104, and the SDRAM 107 for RecOut is connected to the data bus 108 via the SDRAM controller 105.

A D1-I/F (OUT) 109 and a D1-I/F (OUT) 110 are directly connected to the data bus 108. The D1-I/F (OUT) 109 outputs the image signal read from the SDRAM 106 for MonitorOut to a D1-I/F (IN) 111 via the SDRAM controller 104. The D1-I/F (OUT) 110 outputs the image signal read from the SDRAM 107 for RecOut to a D1-I/F (IN) 112 via the SDRAM controller 105.

The D1-I/F (IN1) 111 converts the image signal from the D1-I/F (OUT) 109 into a signal conforming to a data bus 122. The D1-I/F (IN2) 112 converts the image signal from a D1-I/F (OUT) 110 into a signal conforming to the data bus 122. An IDE-I/F 113 controls an HDD 114 by receiving an instruction from a CPU 121.

The HDD 114 records an image signal (JPEG file), etc. from the data bus 122 in response to a control by the IDE-I/F 113, and reads the image signal, etc. to output it to the data bus 122.

A JPEG codec 115 encodes according to the JPEG format the image signal that is input from the D1-I/F (IN1) 112 and temporarily stored in an SDRAM 117 via the data bus 122, and outputs an encoded image signal to the data bus 122. The JPEG codec 115 further decodes the encoded image signal input from the data bus 122 according to the JPEG format, and outputs a decoded image signal to the data bus 122.

An SDRAM controller 116 is a controller for controlling the SDRAM 117, and writes the image signal from the D1-I/F (IN1) 111 or the D1-I/F (IN2) 112 to the SDRAM 117. The SDRAM controller 116 further reads the data from the HDD 114, and writes the read data to the SDRAM 117.

The SDRAM controller 116 also writes the encoded image signal or the decoded image signal output from the JPEG codec 115 to the SDRAM 117. The SDRAM controller 116 further reads an image signal, etc. from the SDRAM 117, and outputs the read image signal, etc. to the data bus 122 or 123.

The SDRAM 117 includes a plurality of storage areas (banks), and each of an image signal, JPEG data, a writing/reading data to be exchanged with HDD 14, etc. is held in each of the plurality of storage areas.

An expansion bus I/F 118 mediates an exchange between a network controller 119 and the data bus 123. The network controller 119 receives a request signal for network access from outside. Furthermore, the network controller 119 receives an instruction from the CPU 121 to send the image signal, etc. held in the SDRAM 117 to the network.

A program for describing a procedure of the CPU 121 is stored in a flash memory 120. The CPU 121 controls each of the above-described constituent elements according to the program within the flash memory 120. Thus, various processes such as recording/reproducing, transmitting a JPEG file via a network, and so forth are realized.

The data bus 122 is directly connected with the D1-I/F (IN1) 111, the D1-I/F (IN2) 112, and the JPEG codec 115. The data bus 122 is further connected with the HDD 114 via the IDE-I/F 113, and connected with the SDRAM 117 via the SDRAM controller 116.

The data bus 123 is directly connected with the flash memory 120 and the CPU 121. The data bus 123 is further connected with the network controller 119 via the expansion bus I/F 118, and connected with the SDRAM 117 via the SDRAM controller 116.

A D1-I/F (OUT) 124 outputs to the external monitor the image signal that is input from the D1-I/F (IN2) 111, and temporarily held in the SDRAM 117 via the data bus 122. The D1-I/F (OUT) 124 further outputs to the external monitor an image signal that is read from the JPEG file within the HDD 114 and decoded by the JPEG codec 115.

The image distribution apparatus in this embodiment distinguishes a multiplexer (MPX) for processing an image from a digital video recorder (DVR) for storing the image. The MPX is connected with a plurality of surveillance cameras, captures an image of each of the surveillance camera at a predetermined timing, and outputs the captured image to the DVR portion.

The image distribution apparatus captures an image from outside such as a surveillance camera, etc., and creates the RecOut and the MonitorOut in the MPX portion. The RecOut is recorded in the DVR, and the MonitorOut is output to the monitor. It is noted that the DVR is recordable at a rate up to maximum of 60 fps. Furthermore, a character such as a recording time period and a REC display, etc. is superimposed on the monitor output from the MPX by an OSD function of the DVR.

Conventionally, a multi-screen displaying operation in the network is realized by use of a MonitorOut path. Here, the MonitorOut path means a processing system of an image input to the DVR from the MPX by use of the D1-I/F (IN1) 111.

However, when the path is utilized, a monitor output screen of the main body and a network output screen have the same image. That is, it is impossible to display an image different between the monitor output screen of the main body and the network output screen. Furthermore, when images of a plurality of channels are multi-displayed on the monitor output screen, a resolution of the image of each of the channels is reduced. For example, in a case of multi-displaying of 4 channel, the resolution of the image of each channel is reduced to ½.

In this embodiment, the RecOut path is utilized for the network output to separate the network output screen from the monitor output screen of the main body. Thus, it is possible to display an image different from the monitor output screen on the network output screen, and further prevent degradation of the resolution.

A system configuration of this embodiment is shown in FIG. 15. When a multi-screen is constructed by use of the RecOut path, the number of image sizes and the number of images are large, and therefore, this reflects on an image updating speed in the network. That is, when an input from the conventional MonitorOUT is received in the D1 input, since an MPX screen mode (FULL image mode, four-part split image mode, MULTI image mode) is continued, the input is output (720×240) as it is in order to create a multi-image of four-part split screen.

However, since the RecOUT is utilized in a current system, an input image is an image of each channel, and therefore, the images of each of the channels has to be pasted with each other in order to create a multi-screen on the network. That is, four sheets of images of 720×240 are needed in order to create the multi-screen of 4 screens, and thus, the number of the sizes and the number of the images are large.

In order to prevent this problem, with respect to a current request from a client, when one request of an image is present, a next request is not generated until an image is obtained. Only one sheet of a memory for image output is prepared, and when a next request is accepted on distribution, it may be possible that a content of the memory on distribution is lost, and therefore, the following request accepted on distribution is waited by performing an exclusive control.

On the contrary thereto, the present invention allows simultaneous requests of a plurality of images. A method for realization is to perform the exclusive control and a memory management for every channel, and accept an image request except for that from the same channel. The client is controlled for every channel, and when the requesting channel is obtained, a display is performed on the browser, and after display, a following image is requested to the server. During obtaining the image, another channel is operated, and even if it takes much time to obtain one channel image, a request and processing from another channel is never waited.

FIG. 16 is a flowchart showing an operation of a server side of the present invention. When a request from the client is accepted, a task on the network is activated (S101) to obtain a requesting channel of the client (S102). If the exclusive control of the designated channel (S103) is not present, the image request is accepted (S104), and the exclusive control of the channel is started (S105).

Thereafter, waiting is performed until an image obtained from the RecOut path is coincident with the requesting channel (S106), and when it is coincident with the requesting channel (S107), a JPEG compression is performed (S108) to develop JPEG data in a memory for the requesting channel (S109). After developing in the memory, the JPEG data is transmitted to the client (S110). After completion of the transmission (S111), an exclusive control for the requesting channel is released (S112) to suspend the task (S113).

A request from the client is accepted during the waiting time period also, and a process according to the flowchart can be similarly executed. If it is the request from another channel, a coincidence of the channel from the RecOut path is waited irrespective of the exclusive control. Requests from a plurality of channels are simultaneously waited for the coincidence of the respective requesting channels, and whereby, it is possible to create a cue for every channel, capable of eliminating a waste at a time of obtaining a channel image from the RecOut path. By performing such the efficient image acquisition and image distribution, it is possible to speed up the image updating speed.

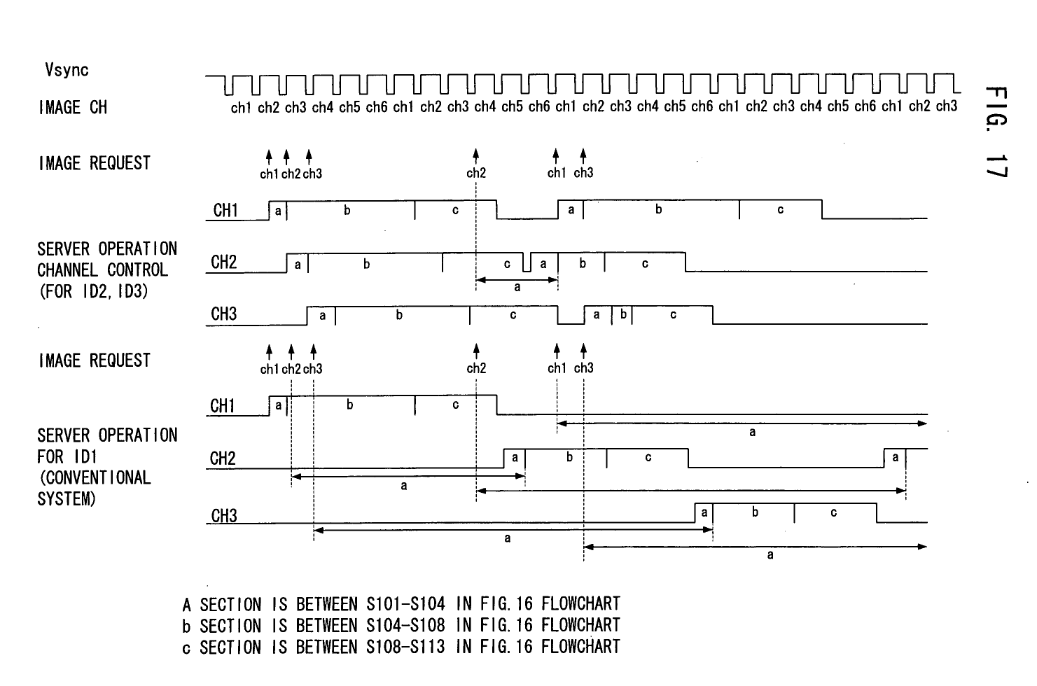

FIG. 17 is timing charts in a channel control system of this embodiment and in a conventional system. One in a low user level is ID1 here. On the other hand, one in a high user level is ID2 or ID3 here. As to the ID1, a control according to the conventional system is performed, and as to the ID2 or the ID3, a channel control system according to this embodiment is performed. An image CH in the drawing indicates an input image channel from the RecOut path. Sections a, b, c in the drawing respectively indicate steps S111-S114, S114-S118, and S118-S113 shown in FIG. 16.

Each of a pulse display such as CH1, CH2, CH3, etc. in the drawing indicates that the server accepts an image request from the client at the leading edge, and indicates that the server completes the image distribution to the client at the falling edge. In the channel control system, requests from the client are accepted to perform the respective processing operations when they are from different channels. On the contrary thereto, in the conventional system, when an image request from any one of the channels is present, a processing operation is performed only when a preceding process is completed.

Thus, as to the ID1 of the low user level, a conventional system is utilized, and as to the ID2 or the ID3 of the high user level, a channel control system is utilized, and whereby, it is possible to perform an efficient image acquisition and image distribution, capable of improving the image updating speed. Furthermore, by changing the control system for every user, it is possible to represent a difference of the image updating speed for each user.

Although the present invention has been described and illustrated in detail, it is clearly understood that the same is by way of illustration and example only and is not to be taken by way of limitation, the spirit and scope of the present invention being limited only by the terms of the appended claims.

1. A data transfer apparatus, comprising:
an acceptor for accepting a transfer request for requesting data transfer to a data processing apparatus having M (M: is two or more integer) first sockets;
N (N: is two or more integer) second sockets;
a transferor for transferring to said data processing apparatus data according to the transfer request accepted by said acceptor via an available second socket out of said N second sockets;
a determiner for determining whether or not the number of transfer operations simultaneously executed by said transferor is below each of said M and said N; and
a controller for allowing the transfer operation by said transferor when a determination result by said determiner is affirmative.

2. A data transfer apparatus according to claim 1, further comprising:
a former for forming memory areas corresponding to a smaller numerical value out of said M and said N within an internal memory; and
an assignor for respectively assigning the memory areas formed by said former to the transfer operations to be simultaneously executed by said transferor.

3. A data transfer apparatus according to claim 1, further comprising a fetcher for fetching a plurality of channels of data, wherein said transfer request includes channel information indicative of any one of said plurality of channels, and said transferor includes an extractor for extracting data corresponding to said channel information.

4. A data transfer apparatus according to claim 3, wherein said transferor further includes a compressor for compressing the data extracted by said extractor.

5. A data transfer apparatus according to claim 3, wherein said fetcher includes a multiplexer for multiplexing data of each of said plurality of channels by a predetermined amount, and the amount of data extracted by said extractor is equal to said predetermined amount.

6. A data transfer apparatus according to claim 3, wherein said fetcher includes a selector for selecting each of said a plurality of channels in a predetermined order, and said extractor waits for appearance of data of the channel according to said transfer request.

7. A data transfer apparatus according to claim 1, wherein said acceptor accepts said transfer request from said data processing apparatus.

8. A data transfer apparatus according to claim 1, wherein said data processing apparatus issues an access request prior to said transfer request, and said data transfer apparatus further comprising a detector for detecting the number of first sockets belonging to said data processing apparatus in response to said access request.

9. A data transfer apparatus according to claim 1, wherein the data to be transferred by said transferor is image data of an object scene imaged by a surveillance camera.

10. A data transfer program to be executed by a processor of a data transfer apparatus, comprising:
an accepting step for accepting a transfer request for requesting data transfer to a data processing apparatus having M (M: is two or more integer) first sockets;
a transferring step for transferring to said data processing apparatus data according to the transfer request accepted by said accepting step via an available second socket out of said N second sockets;
a determining step for determining whether or not the number of transfer operations simultaneously executed by said transferring step is below each of said M and said N; and
a controlling step for allowing the transfer operation by said transferring step when a determination result by said determining step is affirmative.

11. An image server storing a plurality of channels of images, wherein image distribution requests of a plurality of channels from one client connected to said image server via a network is simultaneously accepted, and an image is distributed for each channel accepting said image distribution request.

12. An image server according to claim 11, wherein when a channel of an image input to the image server and a channel of an image requested from the client is coincident with each other, the image is distributed to the client, and while the channels are not coincident with each other, an image queue for waiting distribution is created for each channel.

13. An image server system comprising an image server storing a plurality of channels of images connected via a network and a client requesting an image to said image server, wherein a plurality of channels of image distribution requests from said client are simultaneously accepted, and said client creates a multi-screen on the basis of an image distributed by said image distribution request.

14. An image server adopting a multi-user system for accessing an HTTP server, wherein an updating speed of images is differentiated according to priority of the client.
